(19) United States
(12) Patent Application Publication
(10) Pub. No.: US 2026/0082064 A1
(43) Pub. Date: Mar. 19, 2026

(54) METHOD AND APPARATUS FOR ENCODING AND DECODING POINT CLOUD DATA

(71) Applicant: Electronics and Telecommunications Research Institute, Daejeon (KR)

(72) Inventors: Jun Sik KIM, Daejeon (KR); Soo Woong KIM, Daejeon (KR); Ji Hoon DO, Daejeon (KR); Seong Jun BAE, Daejeon (KR); Gun BANG, Daejeon (KR); Ha Hyun LEE, Daejeon (KR); Jung Won KANG, Daejeon (KR); Jin Soo CHOI, Daejeon (KR)

(73) Assignee: Electronics and Telecommunications Research Institute, Daejeon (KR)

(21) Appl. No.: 19/326,895

(22) Filed: Sep. 12, 2025

(30) Foreign Application Priority Data
Sep. 13, 2024 (KR) 10-2024-0126039
Jul. 9, 2025 (KR) 10-2025-0092624

(51) Int. Cl. H04N 19/42; H04N 19/105; H04N 19/157; H04N 19/167; H04N 19/46

(52) U.S. Cl. CPC H04N 19/42; H04N 19/105; H04N 19/157; H04N 19/167; H04N 19/46

(57) ABSTRACT

A method for decoding a point cloud according to a present disclosure, the method comprises: obtaining a bitstream for an encoded point cloud based on a neural network; and reconstructing the point cloud by decoding the bitstream, wherein the bitstream includes an SPS and a GPS, and wherein the GPS includes identifier information of the SPS corresponding to the GPS.

### CROSS-REFERENCE TO RELATED APPLICATIONS

This application claims the benefit of earlier filing date and right of priority to Korean Application No. 10-2024-0126039, filed on Sep. 13, 2024, Korean Application No. 10-2025-0092624, filed on Jul. 9, 2025, the contents of which are all hereby incorporated by reference herein in their entirety.

### TECHNICAL FIELD

The present disclosure relates to a method and apparatus for encoding/decoding point cloud data. More specifically, the present disclosure relates to a method and apparatus for encoding/decoding point cloud data generated based on artificial intelligence. The present invention may be utilized in fields such as metaverse applications or augmented reality (AR)/virtual reality (VR).

### BACKGROUND

Head-Mounted Displays (HMDs) used in virtual reality and augmented reality (AR) are becoming increasingly popular, and consumption and acquisition of 3D images are becoming more active, with each smartphone equipped with a spatial scanning sensor. Among 3D image data, point cloud data comprises millions to tens of millions of points, so efficient compression technology for point cloud data is essential.

The international standardization organization ISO/IEC JTC1/SC29 WG7 3DGH (3D Graphics coding and Haptics coding) has begun standardizing compression technology that utilizes artificial intelligence for efficient compression of point clouds.

### SUMMARY

The technical object of the present disclosure is to provide a method for transmitting and receiving compressed (generated) point cloud data based on artificial intelligence and/or signal processing.

It is a further object of the present disclosure to provide a method for encoding/decoding sequence information and compression technology information separately.

It is a further object of the present disclosure to provide a method for transmitting and receiving compressed point cloud data based on adaptive arithmetic coding.

The features briefly summarized above regarding the present disclosure are merely exemplary aspects of the detailed description of the present disclosure that follows and do not limit the scope of the present disclosure.

In accordance with an aspect of the present disclosure, the above and other objects can be accomplished by the provision of a method for decoding a point cloud, the method comprising: obtaining a bitstream for an encoded point cloud based on a neural network; and reconstructing the point cloud by decoding the bitstream, wherein the bitstream includes an SPS and a GPS, and wherein the GPS includes identifier information of the SPS corresponding to the GPS.

In the method for decoding the point cloud according to the present disclosure, the GPS includes at least one of structural information of the neural network used to compress position information for the point cloud, the number of neural networks, identifier information of the neural network, information of the neural network, or flag information indicating whether weights used in the neural network are included in the bitstream.

In the method for decoding the point cloud according to the present disclosure, the information of the neural network includes at least one of the number of input features of the neural network, characteristic information of the input features, the number of channels of the input features, the number of output features of the neural network, characteristic information of the output features, or the number of channels of the output features.

In the method for decoding the point cloud according to the present disclosure, the GPS includes flag information indicating whether signal processing-based compression is performed to compress position information for the point cloud, and based on the value of the flag information being true, at least one of the number of signal processing-based codecs used to compress the position information, identifier information of the signal processing-based codec, or type of the signal processing-based codec is signaled.

In the method for decoding the point cloud according to the present disclosure, the bitstream further includes an HPS, and the HPS includes identifier information of the SPS corresponding to the HPS.

In the method for decoding the point cloud according to the present disclosure, the HPS includes compression method information according to data type of the point cloud, based on the compression method information indicating a first compression method in which signal processing-based compression is performed on position information, identifier information of a signal processing-based codec used for compression of the position information is signaled, based on the compression method information indicating a second compression method in which signal processing-based compression is performed on attribute information, identifier information of a signal processing-based codec used for compression of the attribute information is signaled, and based on the compression method information indicating a third compression method in which signal processing-based compression is performed on position information and attribute information, identifier information of a signal processing-based codec used for compression of the position information and identifier information of a signal processing-based codec used for compression of the attribute information are signaled.

In the method for decoding the point cloud according to the present disclosure, the bitstream further includes a GDU, and the GDU includes identifier information of the GPS corresponding to the GDU.

In the method for decoding the point cloud according to the present disclosure, the GDU includes compression method information used for position information compression, and based on the compression method information indicating a compression method of either P-type or B-type, identifier information of a reference frame is signaled.

In the method for decoding the point cloud according to the present disclosure, the GDU includes an arithmetic coding type used to compress position information for the point cloud, and based on the arithmetic coding type is a neural network-based arithmetic coding type, identifier information of the neural network used for the arithmetic coding is signaled.

In the method for decoding the point cloud according to the present disclosure, the bitstream further includes an HDU, and the HDU includes identifier information of an HPS corresponding to the HDU.

In the method for decoding the point cloud according to the present disclosure, the HPS includes compression method information according to data type of the point cloud, and the HDU includes identifier information of a slice on which signal processing-based compression is performed.

In the method for decoding the point cloud according to the present disclosure, based on the compression method information indicating a first compression method in which signal processing-based compression is performed on position information, identifier information of the slice including the position information on which signal processing-based compression is performed is signaled in the HDU, based on the compression method information indicating a second compression method in which signal processing-based compression is performed on attribute information, identifier information of the slice including the attribute information on which signal processing-based compression is performed is signaled in the HDU, and based on the compression method information indicating a third compression method in which signal processing-based compression is performed on position information and attribute information, identifier information of the slice including the position information on which signal processing-based compression is performed and identifier information of the slice including the attribute information on which signal processing-based compression is performed are signaled in the HDU.

In accordance with an aspect of the present disclosure, the above and other objects can be accomplished by the provision of a method for encoding a point cloud, the method comprising: generating a bitstream by encoding the point cloud based on a neural network; and transmitting the bitstream, wherein the bitstream includes an SPS and a GPS, and wherein the GPS includes identifier information of the SPS corresponding to the GPS.

In the method for encoding the point cloud according to the present disclosure, the GPS includes the information of the neural network used to compress position information for the point cloud, and the information of the neural network includes at least one of the number of input features of the neural network, characteristic information of the input features, the number of channels of the input features, the number of output features of the neural network, characteristic information of the output features, or the number of channels of the output features.

In the method for encoding the point cloud according to the present disclosure, the bitstream further includes an HPS, the HPS includes compression method information according to data type of the point cloud, based on the compression method information indicating a first compression method in which signal processing-based compression is performed on position information, identifier information of a signal processing-based codec used for compression of the position information is signaled, based on the compression method information indicating a second compression method in which signal processing-based compression is performed on attribute information, identifier information of a signal processing-based codec used for compression of the attribute information is signaled, and based on the compression method information indicating a third compression method in which signal processing-based compression is performed on position information and attribute information, identifier information of a signal processing-based codec used for compression of the position information and the attribute information are signaled.

In the method for encoding the point cloud according to the present disclosure, the bitstream further includes a GDU, the GDU includes compression method information used for position information compression, and based on the compression method indicating a compression method of either P-type of B-type, identifier information of a reference frame is signaled.

In the method for encoding the point cloud according to the present disclosure, the GDU includes an arithmetic coding type used to compress position information for the point cloud, and based on the arithmetic coding type is a neural network-based arithmetic coding type, identifier information of the neural network used for the arithmetic coding is signaled.

In the method for encoding the point cloud according to the present disclosure, the bitstream further includes an HDU, the HDU includes identifier information of an HPS corresponding to the HDU, the HPS includes compression method information according to data type of the point cloud, and the HDU includes identifier information of a slice on which signal processing-based compression is performed.

In the method for encoding the point cloud according to the present disclosure, based on the compression method information indicating a first compression method in which signal processing-based compression is performed on position information, identifier information of the slice including the position information on which signal processing-based compression is performed is signaled in the HDU, based on the compression method information indicating a second compression method in which signal processing-based compression is performed on attribute information, identifier information of the slice including the attribute information on which signal processing-based compression is performed is signaled in the HDU, and based on the compression method information indicating a third compression method in which signal processing-based compression is performed on position information and attribute information, identifier information of the slice including the position information on which signal processing-based compression is performed and identifier information of the slice including the attribute information on which signal processing-based compression is performed are signaled in the HDU.

In accordance with an aspect of the present disclosure, the above and other objects can be accomplished by the provision of a recording medium for storing a bitstream generated by a point cloud encoding method according to the present disclosure.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

FIG. 1 is a flowchart illustrating a point cloud encoding method based on artificial intelligence according to one embodiment of the present disclosure.

FIG. 2 is a flowchart illustrating a point cloud decoding method based on artificial intelligence according to one embodiment of the present disclosure.

FIG. 3 is a diagram illustrating an example of adaptive arithmetic coding according to one embodiment of the present disclosure.

FIG. 4 is a block diagram illustrating a point cloud data encoding apparatus or a point cloud decoding apparatus.

### DETAILED DESCRIPTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. As an example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. As an example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

A point cloud may refer to a set of points in three-dimensional space. Point cloud data may be represented by coordinate information and/or attribute information.

The coordinate information of the point cloud may represent position information in three-dimensional space. The coordinate information may be represented as values based on a coordinate system (e.g., an orthogonal coordinate system, a spherical coordinate system, etc.).

The attribute information of the point cloud may represent information that quantifies the attributes of a point. For example, it may include at least one of color, transparency, reflectivity, normal vector, or spherical harmonic function.

However, due to the massive volume of point cloud data, compression is essential for providing 3D services such as the metaverse or AR/VR. Accordingly, A1-based point cloud compression technology is actively being researched and is demonstrating high performance. Standardization efforts are also underway to efficiently store and transmit compressed data. In this disclosure, a bitstream structure for effectively storing and transmitting point cloud data generated based on artificial intelligence is proposed.

The bitstream described in this disclosure may be used in the following cases.

1. It may be used when compressing an input point cloud using artificial intelligence compression technology (hereinafter referred to as Case 1).

As an example, artificial intelligence compression technology may perform compression by using neural networks in an end-to-end configuration alone or in conjunction with signal processing compression technology.

2. It may be used when compressing the input point cloud using artificial intelligence compression technology and signal processing compression technology.

More specifically, it can be used to compress point cloud using artificial intelligence compression technology within signal processing compression technology (hereinafter referred to as Case 2).

As an example, AI compression technology may be used to replace some techniques, such as point cloud smoothing and Trisoup generation, in signal processing-based compression technology. For example, the signal processing-based compression technology may include at least one of High Efficiency Video Coding (HEVC), Versatile Video Coding (VVC), Geometry-based Point Cloud Compression (G-PCC), or Video-based Point Cloud Compression (V-PCC).

The bitstream generated through Case 2 may be described within a signal processing-based bitstream structure.

3. It may be used to compress point cloud using AI compression technology and signal processing compression technology.

More specifically, it may be used in cases where point clouds are compressed by applying AI compression technology after signal processing compression technology (hereinafter referred to as Case 3-1), or where point clouds are compressed by applying signal processing compression technology after AI compression technology (hereinafter referred to as Case 3-2).

As an example, point cloud compression may be performed by applying artificial intelligence compression technology to information such as octrees and patches generated after applying signal processing compression technology.

As an example, point cloud compression may be performed by applying a signal processing compression technology to information such as degraded point clouds or 2D images generated after applying AI compression technology, according to characteristics of the generated data.

The bitstream generated through Case 3-1 may be described within a bitstream structure that extends the signal processing-based bitstream structure. The bitstream generated through Case 3-2 may be described within an AI-based bitstream structure.

Previously, a case in which data is compressed based on artificial intelligence and/or signal processing compression technology has been described. Below, the bitstream structure for storing and transmitting compressed data according to the present disclosure will be described in detail.

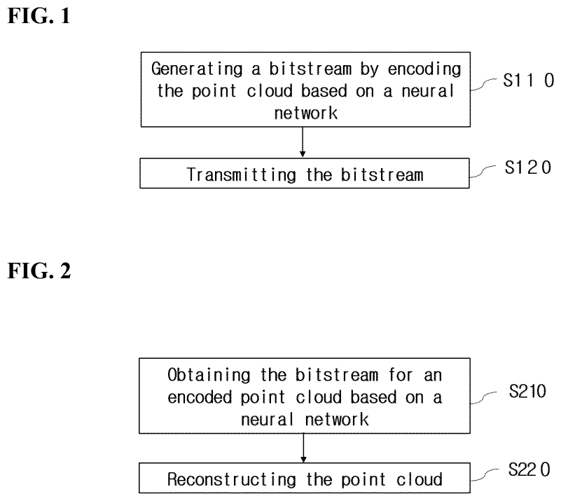

FIG. 1 is a flowchart illustrating a point cloud encoding method based on artificial intelligence according to one embodiment of the present disclosure.

Referring to FIG. 1, a bitstream is generated by encoding the point cloud based on a neural network S110.

Referring to FIG. 1, the bitstream is transmitted S120.

According to one embodiment of the present disclosure, a Neural Network-based Point Cloud Coding (NPC) unit may be defined to perform compression using artificial intelligence.

[Table 1] below shows an example of NPC unit.

TABLE 1

NPC_Coding_Unit( ){
NPC_unit_header( )
NPC_unit_payload( )
}

Referring to Table 1, the NPC unit may represent the basic unit of AI-based compression. The NPC unit may be defined as NPC_Coding_Unit. The NPC unit may include a header (e.g., NPC_unit_header) and a payload (e.g., NPC_unit_payload). [Table 2] shows an example of an NPC unit header.

TABLE 2

| | |
|---|---|
| NPC_unit_header( ){ | |
| npc_unit_type | ue(v) |
| } | |

TABLE 3

npc_unit_type
SPS
GPS
APS
HPS
NDU
GDU
ADU
HDU

Referring to Table 2, the NPC unit header may include an NPC unit type (npc_unit_type). Referring to Table 2, the NPC payload type may be determined based on the NPC unit type.

[Table 3] shows an example of NPC unit type.

The NPC unit type may include at least one of SPS (Sequence Parameter Set), GPS (Geometric Parameter Set), APS (Attribute Parameter Set), HPS (Hybrid coding Parameter Set), NDU (Neural network Data Unit), GDU (Geometric Data Unit), and ADU (Attribute Data Unit), or HDU (Hybrid Data Unit).

However, the disclosed embodiment is only an example, and various unit types may be used when performing artificial intelligence-based point cloud compression.

[Table 4] below shows an example of an NPC unit payload.

TABLE 4

```
NPC_unit_payload( ){
if(npc_unit_type==SPS)
  sequence_parameter_set( )
if(npc_unit_type==GPS)
  geometry_parameter_set( )
if(npc_unit_type==APS)
  attribute_parameter_set( )
if(npc_unit_type==HPS)
  hybrid_coding_parameter_set( )
if(npc_unit_type==NDU)
  nn_data_unit( )
if(npc_unit_type==GDU)
  geometry_data_unit( )
if(npc_unit_type==ADU)
  attribute_data_unit( )
if(npc_unit_type==HDU)
  hybrid_coding_data_unit( )
}
```

The NPC unit payload may include at least one of SPS, GPS, APS, HPS, NDU, GDU, ADU, or HDU, depending on the value of the NPC unit type.

According to the method of the present disclosure, by separating the SPS and GPS and/or APS, point cloud sequence information and point cloud compression technology information may be separately encoded and decoded. In this case, it is possible to prevent the problem of having to retransmit the entire SPS in a transmission environment such as a bit rate change.

Below, parameters for each NPC unit type will be described in detail.

In a Case where the NPC Unit Type is SPS

Table 5 below provides an example of a sequence parameter set for AI-based compression. A SPS may include one or more parameters related to the characteristics, profile, and level of the point cloud. Below, the parameters included in the SPS will be examined in detail.

TABLE 5

| | |
|---|---|
| sequence_parameter_set( ){ | |
| profile_compliant | ue(v) |
| level_idc | ue(v) |
| sequence_parameter_set_id | ue(v) |
| geometry_information( ) | |
| sps_geometry_hybrid_coding_flag | ue(1) |
| attribute_presence_flag | ue(1) |
| if(attribute_presence_flag) | |
| num_attributes | ue(v) |
| for(num_attributes) | |
| sps_attribute_id[ ] | ue(v) |
| sps_attribute_type[ ] | ue(v) |
| attribute_information( )[ ] | |
| sps_attribute_hybrid_coding_flag[ ] | ue(1) |
| nn_data_presence_flag | ue(1) |
| tile_information( ) | |
| } | |

As an example, profile_compliant may mean information indicating whether the bitstream complies with the profile.

As an example, level_idc may mean information about the level that the bitstream follows.

As an example, sequence_parameter_set_id may mean the identifier information of SPS.

For example, geometry_information may refer to information related to position information. The information may include the bit depth of the compressed point cloud, the size of the bounding box, accuracy, and the number of points, etc.

As an example, sps_geometry_hybrid_coding_flag may represent flag information indicating whether a signal processing-based codec is used for position information. In other words, the flag may indicate whether signal processing-based compression is performed on the position information.

As an example, attribute_presence_flag may refer to flag information indicating whether attribute information is present. In other words, the flag may indicate whether attribute information is provided in the bitstream.

As an example, num_attributes may mean the number of attribute information.

As an example, sps_attribute_id may mean the identifier information of attribute information.

As an example, sps_attribute_type may mean the type of attribute information. For example, the type may include at least one of color, transparency, reflectance, normal vector, or spherical harmonic function.

As an example, attribute_information may refer to information related to attribute information. For example, the information may include at least one of the bit depth or offset value of attribute information.

As an example, sps_attribute_hybrid_coding_flag may represent flag information indicating whether a signal processing-based codec is used for attribute information. In other words, the flag may indicate whether signal processing-based compression is performed on the attribute information.

As an example, nn_data_presence_flag may represent flag information indicating whether neural network wights are included in the bitstream.

As an example, tile_information may represent information indicating the tile structure of the bitstream.

In a Case where the NPC Unit Type is GPS

Table 6 below shows an example of a geometry parameter set (GPS) for position information. GPS may include one or more parameters related to the compression of the position information. Below, the parameters in GPS will be examined in detail.

TABLE 6

| | |
|---|---|
| geometry_parameter_set( ){ | |
| gps_sps_id | ue(v) |
| geometry_parameter_set_id | ue(v) |
| gps_networks_list | se(v) |
| gps_num_networks | ue(v) |
| for(gps_num_networks) | |
| gps_network_id[ ] | ue(v) |
| gps_network_information( )[ ] | ue(v) |
| gps_nn_data_presence_flag[ ] | ue(1) |
| if(sps_geometry_hybrid_coding_flag) | |
| gps_num_hybrid_codecs | ue(v) |
| for(gps_num_hybrid_codecs) | |
| gps_hybrid_codec_id[ ] | ue(v) |
| gps_hybrid_codec_type[ ] | ue(v) |
| } | |

As an example, gps_sps_id may mean identifier information of an SPS corresponding to GPS for connection with the SPS.

As an example, geometry_parameter_set_id may mean GPS identifier information.

As an example, gps_networks_list may mean information indicating the structure of the neural network used to compress position information. The information may also indicate connection information between networks.

As an example, gps_num_networks may indicate the number of neural networks used to compress position information. In this case, the unit of the neural network may be set arbitrarily.

As an example, gps_network_id may mean identifier information of the neural network.

As an example, gps_network_information may mean information about the neural network.

As an example, gps_nn_data_presence_flag may refer to flag information indicating whether a neural network used for position information compression is present in the bitstream. More specifically, the information may indicate whether neural network weights used for position information compression are included in the bitstream.

As an example, gps_num_hybrid_codecs may indicate the number of signal processing-based codecs used to compress position information.

As an example, gps_hybrid_codec_id may refer to the identifier information of the signal processing-based codec used to compress position information.

As an example, gps_hybrid_codec_type may indicate the type of signal processing-based codec. The type may include at least one of HEVC, VVC, G-PCC, or V-PCC.

Referring to Table 6, if the value of the sps_geometry_hybrid_coding_flag is signaled as true, at least one of the following information may be signaled: gps_num_hybrid_codecs, gps_hybrid_codec_id, or gps_hybrid_codec_type.

Table 7 below shows an example of parameters related to neural networks. For example, the parameter may be gps_network_information.

TABLE 7

| | |
|---|---|
| gps_network_information( ){ | |
| gps_network_type | ue(v) |
| num_layers | ue(v) |
| for(num_layers) | |
| kernel_size[ ] | ue(v) |
| stride_size[ ] | ue(v) |
| num_weights[ ] | ue(v) |
| num_bias[ ] | ue(v) |
| num_input_feature | ue(v) |
| for(num_input_feature) | |
| input_feature_type | ue(v) |
| num_input_feature_channels[ ] | ue(v) |
| num_output_feature | ue(v) |
| for(num_output_feature) | |
| output_feature_type[ ] | ue(v) |
| num_output_feature_channels[ ] | ue(v) |
| } | |

Referring to Table 7, gps_network_information may include one or more parameters related to the neural network used to compress position information. gps_network_information may provide information about the neural network used to compress the position information. Below, the parameters included in gps_network_information will be examined in detail.

As an example, gps_network_type may indicate the type of neural network. For example, the type may include at least one of MLP, Convolution, Transformer, Entropy Bottleneck, Gaussian Conditional, or Vector Quantization.

As an example, num_layers may refer to the number of layers included in the neural network.

As an example, kernel size, stride_size, num_weights, and num_bias may represent characteristics information of the neural network. Specifically, kernel_size may refer to the size of the filter used for compression. stride_size may refer to the interval at which the filter is applied. num_weights may refer to the number of weights used for compression. num_bias may refer to the number of biases used for compression.

As an example, num_input_feature may mean the number of input features.

As an example, input_feature_type may indicate the characteristic information of an input feature. The characteristic information may include at least one of latent, value, or query.

As an example, num_input_feature_channels may mean the number of channels of the input feature.

As an example, num_output_feature may mean the number of output features.

As an example, output_feature_type may indicate the characteristic information of the output feature. For example, the characteristic information may include at least one of latent, point, or probability.

As an example, num_output_feature_channels may mean the number of the channels of the output feature.

In a Case where the NPC Unit Type is APS

Table 8 below illustrates an example of an attribute parameter set (APS). The APS may include one or more parameters related to attribute compression. Below, the parameters included in the APS will be examined in detail.

TABLE 8

| | |
|---|---|
| attribute_parameter_set( ){ | |
| aps_sps_id | ue(v) |
| attribute_parameter_set_id | ue(v) |
| for(sps_num_attributes) | |
| aps_sps_attribute_id[ ] | ue(v) |
| aps_networks_list | se(v) |
| aps_num_networks[ ] | ue(v) |
| for(aps_num_networks) | |
| aps_network_id[ ][ ] | ue(v) |
| aps_network_information( )[ ][ ] | |
| aps_nn_data_presence_flag[ ][ ] | ue(1) |
| if(sps_attribute_hybrid_coding_flag) | |
| aps_num_hybrid_codecs[ ] | ue(v) |
| for(aps_num_hybrid_codecs) | |
| aps_hybrid_codec_id[ ][ ] | ue(v) |
| aps_hybrid_codec_type[ ][ ] | ue(v) |
| } | |

As an example, aps_sps_id may refer to the identifier information of the SPS corresponding to the APS for connection with the SPS.

As an example, attribute_parameter_set_id may refer to the identifier information of the APS.

As an example, aps_networks_list may represent information about the structure of the neural network used to compress attribute information. The information may also indicate connection information between networks.

As an example, aps_num_networks may indicate the number of neural networks used to compress attribute information. The unit of the neural network may be set arbitrarily.

As an example, aps_network_id may represent the identifier information of the neural network.

As an example, aps_network_information may mean information about the neural network.

As an example, aps_nn_data_presence_flag may refer to flag information indicating whether a neural network used for attribute information compression is present in the bitstream. More specifically, the information may indicate whether neural network weights used for attribute information compression are included in the bitstream.

As an example, aps_num_hybrid_codecs may indicate the number of signal processing-based codecs used to compress attribute information.

As an example, aps_hybrid_codec_id may refer to the identifier information of the signal processing-based codec used to compress attribute information.

As an example, aps_hybrid_codec_type may indicate the type of signal processing-based codec. The type may include at least one of HEVC, VVC, G-PCC, or V-PCC.

Referring to Table 8, if the value of the sps_attribute_hybrid_coding_flag is signaled as true, at least one of the following information may be signaled: aps_num_hybrid_codecs, aps_hybrid_codec_id, or aps_hybrid_codec_type.

Table 9 below shows an example of parameters related to neural networks. For example, the parameter may be aps_network_information.

TABLE 9

| | |
|---|---|
| aps_network_information( ){ | |
| aps_network_type | ue(v) |
| num_layers | ue(v) |
| for(num_layers) | |
| kernel_size[ ] | ue(v) |
| stride_size[ ] | ue(v) |
| num_weights[ ] | ue(v) |
| num_bias[ ] | ue(v) |
| num_input_feature | ue(v) |
| for(num_input_feature) | |
| input_feature_type[ ] | ue(v) |
| num_input_feature_channels[ ] | ue(v) |
| num_output_feature | ue(v) |
| for(num_output_feature) | |
| output_feature_type[ ] | ue(v) |
| num_output_feature_channels[ ] | ue(v) |
| } | |

Referring to Table 9, aps_network_information may include one or more parameters related to the neural network used to compress attribute information. aps_network_information may provide information about the neural network used to compress the attribute information. Below, the parameters included in aps_network_information will be examined in detail.

As an example, aps_network_type may indicate the type of neural network. For example, the type may include at least one of MLP, Convolution, Transformer, Entropy Bottleneck, Gaussian Conditional, or Vector Quantization.

As an example, num_layers may refer to the number of layers included in the neural network.

As an example, kernel size, stride_size, num_weights, and num_bias may represent characteristics information of the neural network. Specifically, kernel_size may refer to the size of the filter used for compression. stride_size may refer to the interval at which the filter is applied. num_weights may refer to the number of weights used for compression. num_bias may refer to the number of biases used for compression.

As an example, num_input_feature may mean the number of input features.

As an example, input_feature_type may indicate the characteristic information of an input feature. The characteristic information may include at least one of latent, value, or query.

As an example, num_input_feature_channels may mean the number of channels of the input feature.

As an example, num_output_feature may mean the number of output features.

As an example, output_feature_type may indicate the characteristic information of the output feature. For example, the characteristic information may include at least one of latent, point, or probability.

As an example, num_output_feature_channels may mean the number of the channels of the output feature.

In a Case where the NPC Unit Type is HPS

Table 10 below shows an example of a parameter set for a signal processing-based compression technology (i.e. hybrid coding parameter set, HPS).

TABLE 10

| | |
|---|---|
| hybrid_coding_parameter_set( ){ | |
| hps_sps_id | ue(v) |
| hybrid_coding_parameter_set_id | ue(v) |
| hps_hybrid_codec_type | ue(v) |
| if(hps_hybrid_codec_type == GC) | |
| hps_gps_hybrid_codec_id | ue(v) |
| codec_paramter_stream( ) | |
| if(hps_hybrid_codec_type == AC) | |
| hps_aps_hybrid_codec_id | ue(v) |
| codec_paramter_stream( ) | |
| if(hps_hybrid_codec_type == GAC) | |
| hps_gps_hybrid_codec_id | ue(v) |
| hps_aps_hybrid_codec_id | ue(v) |
| codec_paramter_stream( ) | |
| } | |

Referring to Table 10, HPS may include one or more parameters related to signal processing-based compression. Below, the parameters included in the HPS will be examined in detail.

As an example, hps_sps_id may refer to the identifier information of the SPS corresponding to the HPS, which is used to connect the HPS to the SPS.

As an example, hybrid_coding_parameter_set_id may refer to the identifier information of the HPS.

As an example, hps_hybrid_codec_type may define a compression method based on data type. The compression method may include at least one of GC (Geometry Coding), AC (Attribute Coding), or GAC (Geometry and Attribute Coding). The GC may refer to a method in which signal processing-based compression is performed on the position information. The AC may refer to a method in which signal processing-based compression is performed on the attribute information. The GAC may refer to a method in which signal processing-based compression is performed on the position information and the attribute information.

As an example, hps_gps_hybrid_codec_id may refer to the identifier information of the GPS corresponding to the HPS, which is used to connect the HPS to the GPS. Additionally, hps_aps_hybrid_codec_id may refer to the identifier information of the APS corresponding to the HPS, which is used to connect the HPS to the APS.

As an example, codec_parameter_stream may refer to a parameter set for the signal processing-based codec.

Referring to Table 10, if hps_hybrid_codec_type is GC, at least one of hps_gps_hybrid_codec_id or codec_parameter_stream may be signaled. In other words, if the compression method information indicates how signal processing-based compression is performed on the position information, at least one of the identifier information of the GPS corresponding to the HPS, or the parameter set of the signal processing-based codec may be signaled.

Referring to Table 10, if hps_hybrid_codec_type is AC, at least one of hps_aps_hybrid_codec_id or codec_parameter_stream may be signaled. In other words, if the compression method information indicates how signal processing-based compression is performed on the attribute information, at least one of the identifier information of the APS corresponding to the HPS, or the parameter set of the signal processing-based codec may be signaled.

Referring to Table 10, if hps_hybrid_codec_type is GAC, at least one of hps_gps_hybrid_codec_id, hps_aps_hybrid_codec_id or codec_parameter_stream may be signaled. In other words, if the compression method information indicates how signal processing-based compression is performed on the position information and the attribute information, at least one of the following may be signaled: the identifier information of the GPS corresponding to the HPS, the identifier information of the APS corresponding to the HPS, or the parameter set of the signal processing-based codec may be signaled.

Meanwhile, Tables 11 to 13 below show examples of parameters related to data units.

Referring to Table 11, geometry_data_unit may include one or more parameters related to the data unit of the position information.

TABLE 11

geometry_data_unit( ){
geometry_data_unit_header( )
geometry_data_payload( )
}

geometry_data_unit may geometry_data_unit_header and/or include geometry_data_payload. The geometry_data_unit_header and the geometry_data_payload will be described in detail with reference to Tables 14 and 15, respectively.

Referring to Table 12, attribute_data_unit may include one or more parameters related to the data unit of the attribute information.

TABLE 12

attribute_data_unit( ){
attribute_data_unit_header( )
attribute_data_payload( )

attribute_data_unit may include attribute_data_unit_header and/or attribute_data_payload. The attribute_data_unit_header and the attribute_data_payload will be described in detail with reference to Tables 16 and 17, respectively.

Referring to Table 13, hybrid_coding_data_unit may perform signal processing-based compression and include one or more parameters.

TABLE 13

hybrid_coding_data_unit( ){
hybrid_coding_data_unit_header( )
hybrid_coding_data_payload( )
}

hybrid_coding_data_unit may include hybrid_coding_data_unit_header and/or hybrid_coding_data_payload. The hybrid_coding_data_unit_header and the hybrid_coding_data_payload will now be described in detail with reference to Tables 18 and 19, respectively.

In a Case where the NPC Unit Type is GDU

Table 14 below shows an example of a data unit header for position information (i.e., geometry_data_unit_header)

TABLE 14

| | |
|---|---|
| geometry_data_unit_header( ){ | |
| gdu_gps_id | ue(v) |
| gdu_slice_id | ue(v) |
| gdu_type | ue(v) |
| if(gdu_type == P) | |
| ref_slice_id | ue(v) |
| if(gdu_type == B) | |
| ref_slice_num | ue(v) |
| for(ref_slice_num) | |
| ref_slice_id[ ] | ue(v) |
| gdu_num_streams | ue(v) |
| for(gdu_num_streams) | |
| stream_type[ ] | ue(v) |
| arithmetic_coding_type[ ] | ue(v) |
| if(arithmetic_codec_type == NN) | |
| gdu_arithmetic_gps_network_id[ ] | ue(v) |
| } | |

Referring to Table 14, the geometry_data_unit_header may indicate the connection structure between the bitstream and the GDU. The geometry_data_unit_header may include one or more parameters. Below, the parameters included in the geometry_data_unit_header will be described.

As an example, gdu_gps_id may refer to the identifier information of the GPS corresponding to the GDU, which is used to connect the GDU to the GPS.

As an example, gdu_slice_id may mean the identifier information of a slice.

As an example, gdu_type may define the compression method used to compress the position information. gdu_type may include at least one of an I-type, a P-type, or a B-type. Specifically, the I-type may refer to an intra-frame compression method. The P-type may refer to an inter-frame compression method that references a previous frame relative to the current time point. The B-type may refer to an inter-frame compression method that references both previous and subsequent frames relative to the current time point.

As an example, ref_slice_id may refer to the identifier information of a reference frame used in inter-frame compression.

Referring to Table 14, ref_slice_id may be signaled when gdu_type is P. Alternatively, one or more ref_slice_id may be signaled when gdu_type is B.

As an example, ref_slice_num may refer to the number of reference frames used for inter-frame compression.

As an example, gdu_num_streams may represent the number of independent bitstreams present in gdu_payload.

As an example, stream_type may indicate the type of data structure representing the compressed bitstream. The type may include a surface, an octree, etc.

As an example, arithmetic_coding_type may refer to the arithmetic coding type used for compression. The type may include CABAC (Context-Adaptive Binary Arithmetic Coding), NN (Neural Network), etc.

As an example, gdu_arithmetic_gps_network_id may indicate the identifier information of the entropy model used when the neural network is used for arithmetic coding. For example, the gdu_arithmetic_gps_network_id may refer to the identifier information of the NN corresponding to the gps_network_id of the GPS. For example, the entropy model may include at least one of Entropy Bottleneck, Gaussian Conditional, or Vector Quantization.

Referring to Table 14, if arithmetic_coding_type is NN, gdu_arithmetic_gps_network_id may be signaled.

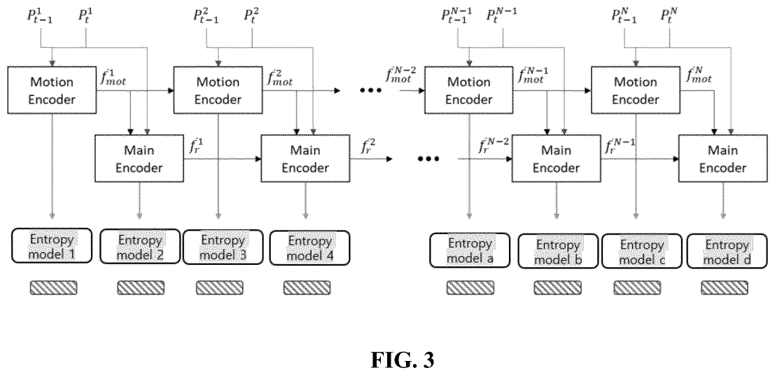

According to one embodiment of the present disclosure, when arithmetic coding is performed using the neural network, identifier information of the entropy model used for each bit depth may be signaled. Accordingly, compressed data may be efficiently stored and transmitted using an optimized entropy model for each probability distribution of latent features. Regarding the arithmetic coding process, it will be examined in detail with reference to FIG. 3 below.

FIG. 3 is a diagram illustrating an example of adaptive arithmetic coding according to one embodiment of the present disclosure.

Referring to FIG. 3, using input information from time points t−1 and t, a motion encoder and a main encoder are applied for each time point, and arithmetic coding is performed on each coding result based on an entropy model.

Referring to FIG. 3, inputs pⁱₜ₋₁ at time t−1 and pⁱₜ at time t may be input to the motion encoder. Here, i may indicate a bit depth. i may be an integer greater than or equal to 1.

In this case, the motion encoder may derive a motion feature fⁱₘₒₜ by receiving point clouds of two time points as input.

The derived motion feature fⁱₘₒₜ may be input to the main encoder. The main encoder may derive a latent feature fⁱᵣ using an input pⁱₜ₋₁, an input pⁱₜ, and a motion feature fⁱₘₒₜ.

In this case, the motion encoder and main encoder may perform arithmetic coding using individual entropy models for each time point. The entropy model may be adaptively determined based on the characteristics of the input point cloud sequence, the compression method (e.g., intra-frame compression or inter-frame compression), or the bit depth. Therefore, the entropy models for individual latent features may be different from each other.

For example, referring to FIG. 3, for p¹ₜ₋₁, input p¹ₜ, the motion encoder may perform arithmetic coding based on entropy model 1, and for p¹ₜ₋₁, input p¹ₜ, the main encoder may perform arithmetic coding based on entropy model 2. For p²ₜ₋₁, input p²ₜ, the motion encoder may perform arithmetic coding based on entropy model 3, and for p²ₜ₋₁, input p²ₜ, the main encoder may perform arithmetic coding based on entropy model 4. For p^{N-1}ₜ₋₁, input p^{N-1}ₜ, the motion encoder may perform arithmetic coding based on entropy model a, and for p^{N-1}ₜ₋₁, input p^{N-1}ₜ, the main encoder may perform arithmetic coding based on entropy model b. For p^{N}ₜ₋₁, input p^{N}ₜ, the motion encoder may perform arithmetic coding based on entropy model c, and for p^{N}ₜ₋₁, input p^{N}ₜ, the main encoder may perform arithmetic coding based on entropy model d.

In this case, the identifier information of the entropy model used for each bit depth may be signaled. Accordingly, compressed data may be efficiently stored and transmitted using an optimized entropy model for each probability distribution of latent features.

Table 15 below shows an example of a data unit payload for position information (i.e., geometry_data_unit_payload).

TABLE 15

geometry_data_unit_payload( ){
for(gdu_num_streams)
arithmetic_stream( )[ ]
}

Referring to Table 15, arithmetic_stream may refer to information defining a data unit for arithmetic coding. For example, a bitstream compressed by a neural network may be arithmetically decoded based on the structure of the neural network used to compress the position information (i.e., gps_networks_list). Alternatively, arithmetic decoding may be performed by referencing a specific network via an identifier.

In a Case where the NPC Unit Type is ADU

Table 16 below shows an example of a data unit header for attribute information (i.e., attribute_data_unit_header)

TABLE 16

| | |
|---|---|
| attribute_data_unit_header( ){ | |
| adu_gps_id | ue(v) |
| adu_slice_id | ue(v) |
| adu_type | ue(v) |
| if(adu_type == P) | |
| ref_slice_id | ue(v) |
| if(adu_type == B) | |
| ref_slice_num | ue(v) |
| for(ref_slice_num) | |
| ref_slice_id[ ] | ue(v) |
| adu_num_streams | ue(v) |
| for(adu_num_streams) | |
| stream_type[ ] | ue(v) |
| arithmetic_coding_type[ ] | ue(v) |
| if(arithmetic_codec_type == NN) | |
| adu_arithmetic_aps_network_id[ ] | ue(v) |
| } | |

Referring to Table 16, attribute_data_unit_header may mean information that indicates the connection structure between the bitstream and ADU. The attribute_data_unit_header may include one or more parameters. Below, the parameters included in the attribute_data_unit_header will be described.

As an example, adu_aps_id may refer to the identifier information of the APS corresponding to the ADU, which is used to connect the ADU to the APS.

As an example, adu_slice_id may mean the identifier information of a slice.

As an example, adu_type may define the compression method used to compress attribute information. adu_type may include at least one of an I-type, a P-type, or a B-type. Specifically, the I-type may refer to an intra-frame compression method. The P-type may refer to an inter-frame compression method that references a previous frame relative to the current time point. The B-type may refer to an inter-frame compression method that references both previous and subsequent frames relative to the current time point.

As an example, ref_slice_id may refer to the identifier information of a reference frame used in inter-frame compression.

Referring to Table 16, ref_slice_id may be signaled when adu_type is P. Alternatively, one or more ref_slice_id may be signaled when adu_type is B.

As an example, ref_slice_num may refer to the number of reference frames used for inter-frame compression.

As an example, adu_num_streams may represent the number of independent bitstreams present in adu_payload.

As an example, stream_type may indicate the type of data structure representing the compressed bitstream. The type may include a surface, an octree, etc.

As an example, arithmetic_coding_type may refer to the arithmetic coding type used for compression. The type may include CABAC (Context-Adaptive Binary Arithmetic Coding), NN (Neural Network), etc.

As an example, adu_arithmetic_gps_network_id may indicate the identifier information of the entropy model used when the neural network is used for arithmetic coding. For example, the entropy model may include at least one of Entropy Bottleneck, Gaussian Conditional, or Vector Quantization.

Referring to Table 16, if arithmetic_coding_type is NN, adu_arithmetic_aps_network_id may be signaled.

According to one embodiment of the present disclosure, when arithmetic coding is performed using the neural network, identifier information of the entropy model used for each bit depth may be signaled. Accordingly, compressed data may be efficiently stored and transmitted using an optimized entropy model for each probability distribution of latent features. As for the arithmetic coding process, it has been examined with reference to FIG. 3 below, and a detailed description thereof will be omitted here.

Table 17 below shows an example of a data unit payload for attribute information (i.e., attribute_data_unit_payload).

TABLE 17

attribute_data_unit_payload( ){
for(adu_num_streams)
arithmetic_stream( )[ ]
}

Referring to Table 17, arithmetic_stream may refer to information defining a data unit for arithmetic coding. For example, a bitstream compressed by a neural network may be arithmetically decoded based on the structure of the neural network used to compress the attribute information (i.e., aps_networks_list). Alternatively, arithmetic decoding may be performed by referencing a specific network via an identifier.

In a Case where the NPC Unit Type is HDU

Table 18 shows an example of a compressed data unit header based on signal processing (i.e., hybrid_coding_ _data_unit_header)

TABLE 18

| | |
|---|---|
| hybrid_coding_data_unit_header( ){ | |
| hdu_hps_id | ue(v) |
| hdu_slice_id | ue(v) |
| if(hdu_hybrid_codec_type == GC) | |
| hdu_gdu_slice_id | ue(v) |
| if(hdu_hybrid_codec_type == AC) | |
| hdu_adu_slice_id | ue(v) |
| if(hdu_hybrid_codec_type == GAC) | |
| hdu_gdu_slice_id | ue(v) |
| hdu_adu_slice_id | ue(v) |
| } | |

Referring to Table 18, the hybrid_coding_data_unit_header may indicate the connection structure between the bitstream and the HDU. The hybrid_coding_data_unit_header may include one or more parameters. Below, the parameters included in the hybrid_coding_data_unit_header will be described.

As an example, hdu_hps_id may refer to the identifier information of the HPS corresponding to the HDU, which is used to connect the HDU to the HPS.

As an example, hdu_slice_id may mean the identifier information of a slice.

As an example, hdu_gdu_slice_id and hdu_adu_slice_id may represent identifier information used to connect a signal processing-based compressed bitstream to a neural network-based compression technology. Specifically, hdu_gdu_slice_id may refer to the identifier information of a slice including position information where compression is performed based on signal processing.

Referring to Table 18, if hps_hybrid_coding_codec_type is GC, hdu_gdu_slice_id may be signaled.

Alternatively, if hps_hybrid_coding_codec_type is AC, hdu_adu_slice_id may be signaled.

Alternatively, if hps_hybrid_coding_codec_type is GAC, hdu_gdu_slice_id and hdu_adu_slice_id may be signaled.

Table 19 below shows an example of a compressed data unit payload based on signal processing (i.e., hybrid_coding_data_unit_payload).

TABLE 19

hybrid_coding_data_unit_payload( ){
for(hdu_num_streams)
arithmetic_stream( )[ ]
}

As an example, arithmetic_stream may refer to information defining a data unit for arithmetic coding.

One or more parameters explained in the present disclosure may be described within a bitstream structure used in a general signal processing-based compression technology or within an extended bitstream structure.

However, the disclosed embodiment is only an example, and it may also be recorded in other structures that are easy to encode/decode.

In addition, in the method of the present disclosure, when using AI-based compression technology in a signal processing-based compression technology, the AI-based compressed data may be stored and transmitted by recording in a general bitstream structure used in the signal processing-based compression technology.

However, the disclosed embodiment is only an example, and various other structures that are easy to encode/decode may also be recorded.

FIG. 2 is a flowchart illustrating a point cloud decoding method based on artificial intelligence according to one embodiment of the present disclosure.

Referring to FIG. 2, a bitstream for an encoded point cloud based on a neural network is obtained S210.

According to one embodiment of the present disclosure, a Neural Network-based Point Cloud Coding (NPC) unit may be signaled to utilize AI compression technology. The NPC unit has been discussed in detail with reference to Table 1, so a detailed description thereof will be omitted here.

The NPC unit may include a header (e.g., NPC_unit_header) and a payload (e.g., NPC_unit_payload). The NPC unit header may include the NPC unit type. With respect to the NPC unit header and NPC unit type, it is as described with reference to Table 2 and 3, respectively. Additionally, with respect to the NPC unit payload, it is as described with reference to Table 4. Therefore, a detailed description thereof will be omitted here.

According to one embodiment of the present disclosure, a sequence parameter set for AI-based compression may be signaled. Referring to Table 5, a detailed description is omitted to avoid redundancy.

According to one embodiment of the present disclosure, a geometry parameter set (GPS) for position information may be signaled. This has been discussed in detail with reference to Table 6, and a detailed description will be omitted to avoid redundancy.

According to one embodiment of the present disclosure, the parameters related to the position information compression neural network, gps_network_information, may be signaled. This has been discussed in detail with reference to Table 7, and a detailed description will be omitted to avoid redundancy.

According to one embodiment of the present disclosure, an attribute parameter set (APS) for attribute information may be signaled. This has been discussed in detail with reference to Table 8, and a detailed description will be omitted to avoid redundancy.

According to one embodiment of the present disclosure, the parameter related to the attribute information compression neural network, aps_network_information, may be signaled. Referring to Table 9, a detailed description is omitted to avoid redundancy.

According to one embodiment of the present disclosure, a hybrid coding parameter set (HPS) for signal processing-based compression technology information may be signaled. This has been discussed in detail with reference to Table 10, and a detailed description will be omitted to avoid redundancy.

According to one embodiment of the present disclosure, parameters for providing compressed data as a bitstream may be signaled.

As an example, geometry_data_unit may be signaled. The geometry_data_unit may include geometry_data_unit_header and/or geometry_data_payload. This has been discussed in Tables 11, 14, and 15, respectively, so a detailed description will be omitted here.

As an example, attribute_data_unit may be signaled. It may include attribute_data_unit_header and/or attribute_data_payload. This has been discussed in Tables 12, 16, and 17, respectively, so a detailed description will be omitted here.

As an example, hybrid_coding_data_unit may be signaled. hybrid_coding_data_unit may include hybrid_coding_data_unit_header and/or hybrid_coding_data_payload. This has been discussed in Tables 13, 18, and 19, respectively, so a detailed description will be omitted here.

Referring to FIG. 2, the point cloud can be reconstructed S220.

The parameters included in the bitstream decoded in step S210 may be selectively used according to the compression technology to generate a reconstructed point cloud.

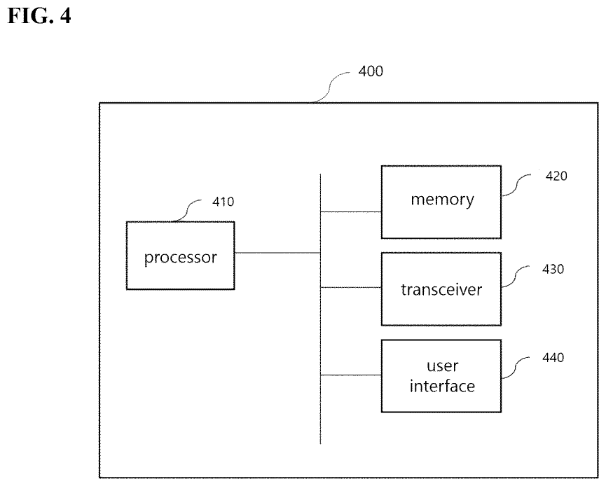

FIG. 4 is a block diagram illustrating a point cloud data encoding apparatus or a point cloud decoding apparatus.

The apparatus 400 may include one or more processors 410, one or more memories 420, one or more transceivers 430, one or more user interfaces 440, etc. The memories 420 may be included in the processor 410 or configured separately. The memory 420 may store instructions that cause the apparatus 400 to perform operations when executed by the processor 410. The transceiver 430 may transmit and/or receive signals, data, etc. that the apparatus 400 exchanges with other entities. The user interface 440 may receive user input for the apparatus 400 or provide output from the apparatus 400 to the user. Components other than the processor 410 and memory 420 of the apparatus 400 may not be included in some cases, and other components not shown in FIG. 4 may be included in the apparatus 400.

The processor 410 may be configured to cause the apparatus 400 to perform operations according to various examples of the present disclosure. Although not illustrated in FIG. 4, the processor 410 may be configured as a collection of modules each performing a function. The modules may be configured in hardware and/or software form.

The apparatus 400 may perform encoding (or compression) of point cloud data and/or may perform decoding (or reconstruction) of point cloud data.

For example, the encoding device 400 can generally support/perform the operation of generating a bitstream and the operation of transmitting a bitstream.

Specifically, the processor 410 of the encoding device 400 may be configured to encode a point cloud based on a neural network to generate a bitstream and transmit the generated bitstream to a decoding device via a transceiver 430. Here, the bitstream includes an SPS and a GPS, and the GPS includes identifier information of the SPS corresponding to the GPS. This has been described in detail with reference to FIG. 1, and a detailed description thereof will be omitted here to avoid redundancy.

For example, the decoding device 400 can generally support/perform the operation of obtaining a bitstream and the operation of reconstructing a point cloud.

For example, the processor 410 of the decoding device 400 may be configured to obtain a bitstream for an encoded point cloud based on a neural network through a transceiver 430 and reconstruct the point cloud by decoding the bitstream. Here, the bitstream includes an SPS and a GPS, and the GPS includes identifier information of the SPS corresponding to the GPS. This has been described in detail with reference to FIG. 2, and a detailed description thereof will be omitted here to avoid redundancy.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method for decoding a point cloud, comprising:
obtaining a bitstream for an encoded point cloud based on a neural network; and
reconstructing the point cloud by decoding the bitstream,
wherein the bitstream includes an SPS and a GPS, and
wherein the GPS includes identifier information of the SPS corresponding to the GPS.

2. The method of claim 1, wherein the GPS includes at least one of structural information of the neural network used to compress position information for the point cloud, the number of neural networks, identifier information of the neural network, information of the neural network, or flag information indicating whether weights used in the neural network are included in the bitstream.

3. The method of claim 2, wherein the information of the neural network includes at least one of the number of input features of the neural network, characteristic information of the input features, the number of channels of the input features, the number of output features of the neural network, characteristic information of the output features, or the number of channels of the output features.

4. The method of claim 1, wherein the GPS includes flag information indicating whether signal processing-based compression is performed to compress position information for the point cloud, and
wherein based on the value of the flag information being true, at least one of the number of signal processing-based codecs used to compress the position information, identifier information of the signal processing-based codec, or type of the signal processing-based codec is signaled.

5. The method of claim 1, wherein the bitstream further includes an HPS, and
wherein the HPS includes identifier information of the SPS corresponding to the HPS.

6. The method of claim 5, wherein the HPS includes compression method information according to data type of the point cloud,
wherein based on the compression method information indicating a first compression method in which signal processing-based compression is performed on position information, identifier information of a signal processing-based codec used for compression of the position information is signaled,
wherein based on the compression method information indicating a second compression method in which signal processing-based compression is performed on attribute information, identifier information of a signal processing-based codec used for compression of the attribute information is signaled, and
wherein based on the compression method information indicating a third compression method in which signal processing-based compression is performed on position information and attribute information, identifier information of a signal processing-based codec used for compression of the position information and identifier information of a signal processing-based codec used for compression of the attribute information are signaled.

7. The method of claim 1, wherein the bitstream further includes a GDU, and
wherein the GDU includes identifier information of the GPS corresponding to the GDU.

8. The method of claim 7, wherein the GDU includes compression method information used for position information compression, and
wherein based on the compression method information indicating a compression method of either P-type or B-type, identifier information of a reference frame is signaled.

9. The method of claim 7, wherein the GDU includes an arithmetic coding type used to compress position information for the point cloud, and
wherein based on the arithmetic coding type is a neural network-based arithmetic coding type, identifier information of the neural network used for the arithmetic coding is signaled.

10. The method of claim 1, wherein the bitstream further includes an HDU, and
wherein the HDU includes identifier information of an HPS corresponding to the HDU.

11. The method of claim 10, wherein the HPS includes compression method information according to data type of the point cloud, and
wherein the HDU includes identifier information of a slice on which signal processing-based compression is performed.

12. The method of claim 11, wherein based on the compression method information indicating a first compression method in which signal processing-based compression is performed on position information, identifier information of the slice including the position information on which signal processing-based compression is performed is signaled in the HDU,
wherein based on the compression method information indicating a second compression method in which signal processing-based compression is performed on attribute information, identifier information of the slice including the attribute information on which signal processing-based compression is signaled in the HDU, and
wherein based on the compression method information indicating a third compression method in which signal processing-based compression is performed on position information and attribute information, identifier information of the slice including the position information on which signal processing-based compression is performed and identifier information of the slice including the attribute information on which signal processing-based compression is performed are signaled in the HDU.

13. A method for encoding a point cloud, comprising:
generating a bitstream by encoding the point cloud based on a neural network; and
transmitting the bitstream,
wherein the bitstream includes an SPS and a GPS, and
wherein the GPS includes identifier information of the SPS corresponding to the GPS.

14. The method of claim 13, wherein the GPS includes the information of the neural network used to compress position information for the point cloud, and
wherein the information of the neural network includes at least one of the number of input features of the neural network, characteristic information of the input features, the number of channels of the input features, the number of output features of the neural network, characteristic information of the output features, or the number of channels of the output features.

15. The method of claim 13, wherein the bitstream further includes an HPS,
wherein the HPS includes compression method information according to data type of the point cloud,
wherein based on the compression method information indicating a first compression method in which signal processing-based compression is performed on position information, identifier information of a signal processing-based codec used for compression of the position information is signaled,
wherein based on the compression method information indicating a second compression method in which signal processing-based compression is performed on attribute information, identifier information of a signal processing-based codec used for compression of the attribute information is signaled, and
wherein based on the compression method information indicating a third compression method in which signal processing-based compression is performed on position information and attribute information, identifier information of a signal processing-based codec used for compression of the position information and the attribute information are signaled.

16. The method of claim 13, wherein the bitstream further includes a GDU,
wherein the GDU includes compression method information used for position information compression, and
wherein based on the compression method indicating a compression method of either P-type of B-type, identifier information of a reference frame is signaled.

17. The method of claim 16, wherein the GDU includes an arithmetic coding type used to compress position information for the point cloud, and
wherein based on the arithmetic coding type is a neural network-based arithmetic coding type, identifier information of the neural network used for the arithmetic coding is signaled.

18. The method of claim 13, wherein the bitstream further includes an HDU,
wherein the HDU includes identifier information of an HPS corresponding to the HDU,
wherein the HPS includes compression method information according to data type of the point cloud, and
wherein the HDU includes identifier information of a slice on which signal processing-based compression is performed.

19. The method of claim 18, wherein based on the compression method information indicating a first compression method in which signal processing-based compression is performed on position information, identifier information of the slice including the position information on which signal processing-based compression is performed is signaled in the HDU,
wherein based on the compression method information indicating a second compression method in which signal processing-based compression is performed on attribute information, identifier information of the slice including the attribute information on which signal processing-based compression is signaled in the HDU, and
wherein based on the compression method information indicating a third compression method in which signal processing-based compression is performed on position information and attribute information, identifier information of the slice including the position information on which signal processing-based compression is performed and identifier information of the slice including the attribute information on which signal processing-based compression is performed are signaled in the HDU.

20. A recording medium for storing a bitstream generated by a method for encoding a point cloud, comprising:
generating a bitstream by encoding the point cloud based on a neural network; and
transmitting the bitstream,
wherein the bitstream includes an SPS and a GPS, and
wherein the GPS includes identifier information of the SPS corresponding to the GPS.
